(19) United States
(12) Patent Application Publication
(10) Pub. No.: US 2009/0298961 A1
(43) Pub. Date: Dec. 3, 2009

(54) MULTI-COMPONENT SYSTEMS, METHOD FOR THE PRODUCTION AND USE THEREOF

(75) Inventors: Hubert Baumgart, Muenster (DE); Lars Hoffman, Muenster (DE); Bjoern Feldmann, Muenster (DE); Uwe Conring, Duelman (DE); Melanie Glomb, Ahlen (DE)

Correspondence Address: BASF CORPORATION;Patent Department, 1609 BIDDLE AVENUE, MAIN BUILDING, WYANDOTTE, MI, 48192, US

(73) Assignee: Basf Coatings AG, Munster (DE)

(21) Appl. No.: 11/720,763

(22) PCT Filed: Nov. 15, 2005
(86) PCT No.: PCT/EP05/55994

§ 371 Date: Aug. 6, 2009

(30) Foreign Application Priority Data
Dec. 20, 2004 (DE) 102004061185.8

(51) Int. Cl. C08F 2/46

(52) U.S. Cl. 522/30; 522/65

(57) ABSTRACT

Multicomponent systems comprising

(A) a component which
contains isocyanate-reactive functional groups,
is free from isocyanate groups, and
contains reactive functional groups having bonds which can be activated with actinic radiation, or is free from these functional groups,
and

(B) a component which
contains isocyanate groups,
is free from isocyanate-reactive functional groups, and
contains reactive functional groups having bonds which can be activated with actinic radiation, or is free from these functional groups,
   one of the two components, (A) or (B), containing functional groups having bonds which can be activated with actinic radiation, and component (A) comprising

(L) a light stabilizer, selected from the group consisting of low molecular mass, oligomeric and polymeric light stabilizers which contain at least one isocyanate-reactive functional group and

(P) a photoinitiator which contains at least one isocyanate-reactive functional group; processes for preparing them, and their use for preparing mixtures curable thermally and with actinic radiation.

The present invention relates to new multicomponent systems. Additionally the present invention relates to a new process for preparing multicomponent systems. The present invention further relates to the use of the new multicomponent systems and of the multicomponent systems prepared by means of the new process for preparing new dual-cure mixtures (mixtures curable thermally and with actinic radiation). The present invention relates not least to the use of the new dual-cure mixtures for producing dual-cured thermoset materials, particularly sheets, moldings, coatings, adhesive layers, and seals.

Multicomponent systems comprising

(A) at least one component which
contains isocyanate-reactive functional groups,
is free from isocyanate groups, and
contains reactive functional groups having bonds which can be activated with actinic radiation, or is free from these functional groups,
and

(B) at least one component which
contains isocyanate groups,
is free from isocyanate-reactive functional groups,
contains reactive functional groups having bonds which can be activated with actinic radiation, or is free from these functional groups,
   at least one of the two components, (A) or (B), containing functional groups having bonds which can be activated with actinic radiation, are known per se. Customarily their components (A) and/or (B) include light stabilizers and photoinitiators. These known multicomponent systems serve, as is known, for preparing dual-cure coating materials.

From German patent application DE 100 10 416 A1 a large number of coating materials curable physically or thermally and/or with actinic radiation are known that can be prepared, inter alia, from two-component or multicomponent systems (cf. DE 100 10 416 A1, page 1, lines 1 to 41).

The dual-cure coating materials contain reactive functional groups having bonds which can be activated with actinic radiation (cf. DE 100 10 416 A1, page 8, lines 45 to 59). It is not indicated that specifically the two-component or multicomponent systems contain these reactive functional groups and are intended to serve for producing dual-cure coating materials.

All coating materials of DE 100 10 416 A1 that are curable physically or thermally and/or with actinic radiation include at least one (meth)acrylate copolymer containing at least one copolymerized light stabilizer. One of four light stabilizer monomers listed expressly also contains an isocyanate-reactive hydroxyl group (cf. DE 100 10 416 A1, page 3, line 31 to page 5, line 32, in conjunction with preparation examples 1 to 5, page 14, line 44 to page 17, line 20). No particular preference for the hydroxyl-containing light stabilizer monomers can be inferred from examples 1 to 5. Nor is there any indication that the (meth)acrylate copolymer containing the hydroxyl-containing light stabilizer monomer in copolymerized form is suitable for use in coating materials that are curable thermally and with actinic radiation and are prepared from multicomponent systems, since the examples reveal only thermally curable one-component systems (cf. DE 100 10 416 A1, page 17, line 21, to page 18, line 28).

From page 12, lines 11 and 12, of DE 100 10 416 A1 it is apparent, in addition, that the photoinitiators known from Römpp Lexikon Lacke und Druckfarben, Georg Thieme Verlag, Stuttgart, New York, 1998, pages 444 to 446, can be used with coating materials curable with actinic radiation or by a dual-cure mechanism. Said Römpp reference cites, with formulae, 15 compounds which come from 9 classes of compound. One of these photoinitiators (2-hydroxy-1-[4-(2-hydroxyethoxy)-phenyl]-2-methyl-1-propanone) contains an isocyanate-reactive hydroxyl group. There is no indication whatsoever, though, that this photoinitiator might be especially suitable for dual-cure coating materials which are prepared from multicomponent systems.

The coating materials known from German patent application DE 100 10 416 A1 and curable physically or thermally and/or with actinic radiation produce clearcoats which have an outstanding profile of optical and mechanical properties, are scratch-resistant and acid-resistant, and exhibit particularly high weathering stability and etch resistance.

Known from German patent application DE 100 42 152 A1 is a two-component system which serves for preparing a dual-cure clearcoat material. The known dual-cure clearcoat material includes two photoinitiators that are free from isocyanate-reactive functional groups (Irgacure® 184 from Ciba Spezialitätenchemie and Genocure® MBF from Rahn Chemie) and a low-volatility photoinitiator (Lucirin® TPO from BASF Aktiengesellschaft) and also a light stabilizer free from isocyanate-reactive functional groups (Tinuvin® 292 from Ciba Spezialitätenchemie) and a light stabilizer containing an isocyanate-reactive hydroxyl group (Tinuvin® 400 from Ciba Spezialitätenchemie). The known dual-cure clearcoat material exhibits excellent Theological behavior, very good application properties, very good durability and very good flow, and provides clearcoats which in terms of gloss, transparency and clarity, weathering stability and yellowing resistance satisfy all of the expectations of the market.

Despite the outstanding profile of properties exhibited by the coatings produced from the known coating materials and cured thermally and with actinic radiation, in terms of gloss, transparency and clarity, weathering stability and yellowing stability, and also etch resistance, scratch resistance and acid resistance, a problem which arises is that the known coatings emit volatile organic compounds, which originate in particular from the shadow zones which have been cured predominately or exclusively by means of heat. In spite of the paucity of these emissions they frequently manifest themselves in disruptive odors, which occur in particular in the interior of new automobiles. This “new auto” smell is known to the automobile customer and he or she frequently perceives it as a nuisance.

It is an object of the present invention to provide new multicomponent systems which are suitable for preparing new dual-cure mixtures (mixtures curable thermally and with actinic radiation) which when cured by a dual-cure mechanism provide new dual-cured thermoset materials which exhibit only very little, if any, emission of volatile organic compounds.

The new multicomponent systems ought to be easy to prepare.

The new mixtures prepared from them and curable thermally and with actinic radiation (dual-cure mixtures) ought additionally to have excellent Theological behavior, very good application properties, very good durability and very good flow.

The new dual-cure mixtures ought to be outstandingly suitable for producing new dual-cured thermoset materials, particularly sheets, moldings, coatings, adhesive layers, and seals. In particular they ought to be suitable as new coating materials for producing new coatings which, in terms of gloss, transparency and clarity, weathering stability and yellowing stability, and also etch resistance, scratch resistance and acid resistance, are equal in stature to the known coatings, if not indeed exceeding them.

Found accordingly have been the new multicomponent systems comprising

(A) at least one component which
contains isocyanate-reactive functional groups,
is free from isocyanate groups, and
contains reactive functional groups having bonds which can be activated with actinic radiation, or is free from these functional groups,
and

(B) at least one component which
contains isocyanate groups,
is free from isocyanate-reactive functional groups, and
contains reactive functional groups having bonds which can be activated with actinic radiation, or is free from these functional groups,
   at least one of the two components, (A) or (B), containing functional groups having bonds which can be activated with actinic radiation, and component (A) or at least one of components (A) comprising

(L) at least one light stabilizer, selected from the group consisting of low molecular mass, oligomeric and polymeric light stabilizers which contain at least one isocyanate-reactive functional group and

(P) at least one photoinitiator which contains at least one isocyanate-reactive functional group.

The new multicomponent systems are referred to below as “systems of the invention”.

Found additionally has been the new process for preparing multicomponent systems comprising

(A) at least one component which
contains isocyanate-reactive functional groups,
is free from isocyanate groups, and
contains functional groups having bonds which can be activated with actinic radiation, or is free from these functional groups,
and

(B) at least one component which
contains isocyanate groups,
is free from isocyanate-reactive functional groups, and
contains functional groups having bonds which can be activated with actinic radiation, or is free from these functional groups,
   with the proviso that at least one of the two components, (A) or (B), contains functional groups having bonds which can be activated with actinic radiation,
   by the separate preparation of components (A) and (B), where component (A) or at least one of components (A) has added to it

(1) at least one light stabilizer (L), selected from the group consisting of low molecular mass, oligomeric and polymeric light stabilizers which contain at least one isocyanate-reactive functional group and

(2) at least one photoinitiator (P) which contains at least one isocyanate-reactive functional group.

The new process for preparing the systems of the invention is referred to below as “process of the invention”.

Found additionally has been the new use of the systems of the invention and of the multicomponent systems prepared by the process of the invention for preparing mixtures curable thermally and with actinic radiation, this being referred to below as “use” in accordance with the invention.

Further subject matter of the invention will emerge from the description.

In the light of the prior art it was surprising and unforeseeable for the skilled worker that the object on which the present invention was based could be achieved by means of the systems of the invention, the process of the invention and the use in accordance with the invention.

In particular it was surprising that the systems of the invention were outstandingly suitable for preparing new dual-cure mixtures which produced new dual-cured thermoset materials which exhibited very little—if any at all—emission of volatile organic compounds.

The systems of the invention were easy to prepare.

The dual-cure mixtures of the invention prepared from them had excellent Theological behavior, very good application properties, very good durability and very good flow.

The dual-cure mixtures of the invention were outstandingly suitable for producing new dual-cured thermoset materials, particularly new sheets and moldings, and also as new coating materials, adhesives and sealants for producing new coatings, adhesive layers, and seals.

In particular they were outstandingly suitable as new coating materials for producing new coatings which, in terms of gloss, transparency and clarity, weathering stability and yellowing stability, and also etch resistance, scratch resistance and acid resistance, were equal in stature to the known coatings, if not indeed exceeding them.

Additionally the new sheets were found to possess pronounced thermal stability and tensile strength, and so were outstandingly suitable as substrates or as packaging materials. The new moldings had particular dimensional stability. The new adhesive layers exhibited a high bond strength even under sharply fluctuating conditions. And the new seals sealed substrates of all kinds durably even against aggressive media.

The systems of the invention are multicomponent systems: that is, they include at least one, especially one, component (A) which contains isocyanate-reactive functional groups and at least one, especially one, component (B) which contains isocyanate groups. The components (A) and (B) are stored separately from one another until their appropriate use.

Preferably the isocyanate-reactive functional groups present in component (A) are selected from the group consisting of hydroxyl groups, thiol groups and primary and secondary amino groups. In particular the isocyanate-reactive functional groups are hydroxyl groups.

Naturally the components (A) contain no free isocyanate groups. They can, however, contain blocked isocyanate groups, blocked with conventional blocking agents, as described for example in German patent application DE 100 42 152 A1, page 6, paragraph [0062].

Components (A) can contain reactive functional groups having bonds which can be activated with actinic radiation, or they can be free from these reactive functional groups. Where components (B) contain no reactive functional groups of this kind, they are mandatorily present in component(s) (A).

The reactive functional groups which contain bonds which can be activated with actinic radiation serve for the curing of the dual-cure mixtures, prepared from the systems of the invention, with actinic radiation. For the purposes of the present invention actinic radiation means electromagnetic radiation, such as near infrared (NIR), visible light, UV radiation, X-rays or gamma radiation, especially UV radiation, and corpuscular radiation such as electron beams, alpha radiation, beta radiation or neutron beams, especially electron beams. Examples of suitable bonds which can be activated with actinic radiation are known from patent application DE 100 42 152 A1, page 3, paragraphs [0021] to [0027]. Preference is given to using olefinically unsaturated double bonds, contained in particular in acrylate and/or methacrylate groups.

The components (A) are preferably liquid under the conditions of their preparation and application, in particular at room temperature.

Apart from the inventively essential use of at least one light stabilizer (L) containing at least one isocyanate-reactive functional group and of at least one photoinitiator (P) likewise containing at least one isocyanate-reactive functional group, the physical composition of component (A) has no particular features; rather, it is possible to use all constituents which are normally employed in the isocyanate-group-free components of multicomponent systems, which is a particular advantage of the systems of the invention.

Suitable constituents for synthesizing component (A) may be selected from the group consisting of binders curable physically, thermally, with actinic radiation, and both thermally and with actinic radiation, crosslinking agents curable thermally and both thermally and with actinic radiation, with the exception of polyisocyanates; low molecular mass and oligomeric reactive diluents curable thermally, with actinic radiation, and both thermally and with actinic radiation, and also additives.

The additives may be selected from the group consisting of color and/or effect pigments, molecularly dispersely soluble dyes, light stabilizers, such as UV absorbers and reversible free-radical scavengers (HALS), which are free from isocyanate-reactive functional groups in the sense of the present invention, especially light stabilizers of low or zero volatility, photoinitiators that are free from isocyanate-reactive functional groups in the sense of the present invention, especially photoinitiators of low or zero volatility, antioxidants, low-boiling and high-boiling (“long”) organic solvents, water, rheology control additives, devolatilizers, wetting agents, emulsifiers, slip additives, polymerization inhibitors, thermal crosslinking catalysts, thermolabile free-radical initiators, adhesion promoters, leveling agents, film-forming auxiliaries, flame retardants, corrosion inhibitors, free-flow aids, waxes, siccatives, biocides, and flatting agents.

Examples of suitable constituents for synthesizing component (A) are described in detail in
international patent application WO 03/016411 A1, page 14, line 9 to page 34, line 9, page 34, line 28 to page 36, line 11, and page 7, line 1 to page 14, line 7;
German patent application DE 100 10 416 A1, page 11, line 29 to page 12, line 9, page 12, lines 13 to 51,
Römpp Lexikon Lacke und Druckfarben, Georg Thieme Verlag, Stuttgart, New York, 1998, “thickeners”, pages 599 to 600,
Johan Bieleman, “Lackadditive” [additives for coatings], Wiley-VCH, Weinheim, New York, 1998, pages 51 to 59 and 65,
German patent application DE 198 41 842 A1, page 4, line 45 to page 5, line 4,
German patent application DE 199 24 170 A1, column 2, line 3 to column 7, line 24,
German patent application DE 199 24 171 A1, page 2, line 44 to page 9, line 32,
German patent application DE 199 24 172 A1, page 2, line 44 to page 3, line 32,
German patent application DE 100 42 152 A1, page 2, paragraph [0010] to page 6, paragraph [0066], and page 7, paragraph [0071] to page 11, paragraph [0093],
German patent application DE 101 26 647 A1, page 2, paragraph [0009] to page 6, paragraph [0066], and
German patent application DE 101 54 030 A1, column 11, paragraph [0064] to column 12, paragraph [0071].

The constituents are used in the conventional, effective amounts.

For the systems of the invention it is essential that their component(s) (A) contain at least one, in particular at least two, light stabilizer(s) (L).

The light stabilizers (L) are selected from the group consisting of low molecular mass, oligomeric and polymeric light stabilizers which contain at least one, especially one, isocyanate-reactive functional group. Preferably they are selected from the group consisting of UV absorbers and reversible free-radical scavengers. Preferably the UV absorbers (L) are selected from the group consisting of benzotriazoles and triazines, and the reversible free-radical scavengers (L) from the group consisting of sterically hindered cyclic amines, especially HALS.

Preferably the isocyanate-reactive functional groups are hydroxyl groups. Hydroxyl groups which are arranged in the immediate vicinity of a benzotriazole system and which therefore interact with a nitrogen of the triazole ring, and also phenol groups which are severely hindered sterically, being located for example between two tertiary butyl groups, are not isocyanate-reactive functional groups in the sense of the present invention.

Examples of suitable low molecular mass light stabilizers (L) are
a mixture of 2-(4-((2-hydroxy-3-undecyloxy-propyl)oxyl)-2-hydroxyphenyl)-4,6-bis(2,4-dimethylphenyl)-1,3,5-triazine and 2-(4-((2-hydroxy-3-tridecyloxypropyl)oxyl)-2-hydroxyphenyl)-4,6-bis(2,4-dimethylphenyl)-1,3,5-triazine, which is sold under the brand name Tinuvin® 400 by Ciba Spezialitätenchemie,
the Ciba Spezialitätenchemie trial product Tinuvin® CGL 052, which contains one triazine group and two cyclic, sterically hindered amino ether groups, and
the light stabilizer monomer (a3) described in German patent application DE 100 10 416 A1, page 4.

Examples of suitable oligomeric and polymeric light stabilizers (L) are the (meth)acrylate copolymers of the light stabilizer monomer (a3) that are described in German patent application DE 100 10 416 A1, page 3, line 31 to page 5, line 32, and page 14, line 42 to page 17, line 20.

The amount of the light stabilizers (L) for inventive use in component (A) can vary very widely and is guided by the requirements of the case in hand. Preferably the light stabilizers (L) are used in the amounts conventional and effective for light stabilizers, preferably in an amount of 0.1% to 5%, preferably 0.2% to 4.5%, more preferably 0.3% to 4%, very preferably 0.4% to 3.5%, and in particular 0.5% to 3% by weight, based in each case on (A).

For the systems of the invention it is further essential that their component(s) contain at least one photoinitiator (P) and in particular at least two photoinitiators (P) having at least one, in particular one, isocyanate-reactive functional group.

Preferably the photoinitiators (P) are selected from the group consisting of benzil monoketals, acetophenone derivatives, benzyl formates, monoacylphosphine oxides and diacylphosphine oxides. In particular the photoinitiators (P) are acetophenone derivatives.

The isocyanate-reactive functional groups are preferably hydroxyl groups. Hydroxyl groups which interact via the keto-enol tautomerism with an adjacent carbonyl group and/or which are severely hindered sterically are not isocyanate-reactive functional groups in the sense of the invention.

One example of a suitable photoinitiator (P) is
1-[4-(2-hydroxyethoxy)phenyl]-2-hydroxy-2-methyl-1-propan-1-one,
   which is sold under the brand name Irgacure® 2959 by Ciba Spezialitätenchemie.

The amount of the photoinitiators (P) for inventive use in component (A) can vary very widely and is guided by the requirements of the case in hand. Preferably the photoinitiators (P) are used in the conventional amounts effective for photoinitiators, preferably in an amount of 0.1% to 5%, preferably 0.2% to 4.5%, more preferably 0.3% to 4%, very preferably 0.4% to 3.5%, and in particular 0.5% to 3% by weight, based in each case on (A).

The component(s) (B) of the systems of the invention contain or contains isocyanate groups.

The components (B) can contain the above-described blocked isocyanate groups in minor amounts, i.e. in amounts <50, preferably <40, more preferably <30 and in particular <20 equivalent %, based on the blocked and unblocked isocyanate groups present.

Naturally the components (B) are free from the above-described isocyanate-reactive functional groups.

The components (B) can contain the above-described reactive functional groups having bonds which can be activated with actinic radiation, or they can be free from these reactive functional groups. Where components (A) contain no reactive functional groups of this kind, they are mandatorily present in the components (B).

Preferably the components (B) are liquid under the conditions of their preparation and their application, in particular at room temperature.

The components (B) comprise polyisocyanates or consist of them.

As polyisocyanates it is possible to use the polyisocyanates such as are commonly used in the paints field, in other words the paint polyisocyanates, as they are known. Preferably these have a mean isocyanate functionality of 2 to ≦6, in particular >2 to ≦6. Examples of suitable polyisocyanates are described for example in German patent application DE 100 42 152 A1, page 4, paragraph [0037] to page 6, paragraph [0063], in German patent application DE 100 10 416 A1, page 8, lines 28 to 44, or in international patent application WO 03/016411, page 33, line 27 to page 34, line 9.

Components (B) can contain the additives described above, provided the latter do not react with the polyisocyanates. In particular the components (B) can contain the above-described light stabilizers and photoinitiators that are free of isocyanate-reactive functional groups in the sense of the present invention. Components (B) of this kind are described for example in European patent application EP 0 952 170 A1, page 5, paragraphs [0042] and [0043], in conjunction with page 6, paragraphs [0046] and [0051], and also page 7, paragraphs [0054] and [0057].

Preferably the systems of the invention are prepared with the aid of the process of the invention. For that purpose components (A) and (B) of the systems of the invention are prepared separately from one another, from the constituents described above, and stored separately from one another until their use in accordance with the invention.

For the process of the invention it is essential that the above-described light stabilizers (L) and photoinitiators (P) be added to component (A) or to at least one of the components (A) of a system of the invention. Preferably the process of the invention is carried out in the absence of actinic radiation.

Preferably the preparation of components (A) and (B) takes place by mixing their respective constituents with one another and homogenizing the resulting mixtures. With preference this is done using the conventional mixing methods and apparatus such as stirred tanks, agitator mills, extruders, kneading apparatus, Ultraturrax, inline dissolvers, static mixers, micromixers, toothed-wheel dispersers, pressure release nozzles and/or microfluidizers, preferably in the absence of actinic radiation.

The resulting components (A) and (B) of a given system of the invention are preferably conventional components containing organic solvents, aqueous components, and/or substantially or entirely solvent-free and water-free liquid components (100% systems).

The systems of the invention may be put to an extremely wide diversity of uses. In particular they are used for preparing mixtures curable thermally and with actinic radiation (dual-cure mixtures; “mixtures of the invention”).

Preferably the mixtures of the invention serve for the production of new dual-cured thermoset materials.

With preference the mixtures of the invention serve for the production of new sheets and moldings, and also as new coating materials, adhesives and sealants for producing new coatings, adhesive layers, and seals.

The mixtures of the invention are preferably coating materials (“coating materials of the invention”).

With particular preference the coating materials of the invention are used as new electrocoat materials, primer coats, surfacers or antistonechip primers, basecoat materials, solid-color topcoat materials and clearcoat materials for producing new electrocoats, primer coats, surfacer coats or antistonechip primer coats, basecoats, solid-color topcoats and clearcoats. These coating systems of the invention may be single-coat or multicoat systems. With particular preference they are multicoat systems and in that case may comprise at least two coats, in particular at least one electrocoat, at least one surfacer coat or antistone-chip primer coat, and also at least one basecoat and at least one clearcoat or at least one solid-color topcoat. With particular preference the multicoat paint systems of the invention comprise at least one basecoat and at least one clearcoat.

It is of particular advantage to produce the clearcoat of the multicoat paint systems of the invention from the mixtures of the invention. The clearcoats comprise the outermost coat of the multicoat paint systems, which substantially determines the overall visual appearance and protects the color and/or effect basecoats against mechanical and chemical damage and against damage due to radiation. In terms of gloss, transparency and clarity, weathering stability and yellowing stability, and also etch resistance, scratch resistance and acid resistance, the clearcoats of the invention have an outstanding profile of properties. Surprisingly they also have a high condensation resistance. In particular, however, the clearcoats of the invention, even at temperatures of 90° C. or more, exhibit only very little emission of volatile organic compounds, and so also no longer give rise to any odor nuisance in enclosed spaces, particularly in the interiors of new automobiles.

The particular advantage of the absence of odor nuisance is also possessed by the moldings, sheets, other coatings, adhesive layers, and seals of the invention.

The production of the thermoset materials of the invention, particularly of the moldings, sheets, coatings, adhesive layers, and seals of the invention, has no peculiarities in terms of method; instead, in accordance with the intended use, the mixtures of the invention are applied to conventional temporary or permanent substrates.

For producing sheets and moldings of the invention it is preferred to use conventional temporary substrates such as metallic and polymeric belts or hollow bodies of metal, glass, plastic, wood or ceramic, which can be easily removed without damaging the sheets and moldings of the invention.

Where the mixtures of the invention are used for producing coatings, adhesive layers, and seals, permanent substrates are used, such as bodies of means of transport, especially motor vehicle bodies, and parts thereof, buildings, in the interior and exterior and parts thereof, doors, windows and furniture, and, in the context of industrial coating, hollow glassware, coils, containers, packaging, small parts, electrical, mechanical and optical components, and components for white goods. The sheets and moldings of the invention may likewise serve as substrates.

In terms of method the application of the mixtures of the invention has no peculiarities but may instead take place by any conventional application methods suitable for the mixture in question, such as by spraying, squirting, knifecoating, brushing, flowcoating, dipping, trickling or rolling, for example. Preference is given to employing spray application methods.

In the course of application it is advisable to operate in the absence of actinic radiation, in order to prevent premature crosslinking of the mixtures of the invention.

For producing the multicoat paint systems of the invention it is possible to employ wet-on-wet methods and system designs which are known, for example, from German patent application DE 199 30 067 A1, page 15, line 23 to page 16, line 36. It is an essential advantage of the use in accordance with the invention that all coats of the multicoat paint systems of the invention can be produced from the mixtures of the invention.

The mixtures of the invention are generally cured after a certain rest time or flash-off time. This may have a duration of 30 s to 2 h, preferably 1 min to 1 h and in particular 1 to 45 min. The rest time serves for example for the flow and devolatilization of the applied mixtures of the invention and for the evaporation of volatile constituents such as any solvent present. Flashing off may be accelerated by means of an increased temperature, but still less than that required for curing, and/or by means of reduced air humidity.

The thermal curing of the applied mixtures takes place for example with the aid of a gaseous, liquid and/or solid, hot medium, such as hot air, heated oil or heated rollers, or of microwave radiation, infrared light and/or near infrared (NIR) light. Preferably the heating takes place in a forced-air oven or by irradiation using IR and/or NIR lamps. As in the case of the actinic radiation cure, thermal curing as well may take place in stages. Thermal curing takes place advantageously at temperature from room temperature to 200° C.

In the case of the actinic radiation cure it is preferred to use a radiation dose of 10³ to 3×10⁴, preferably 2×10³ to 2×10⁴, more preferably 3×10³ to 1.5×10⁴ and in particular 5×10³ to 1.2×10⁴ Jm⁻². The radiation intensity is 1×10⁰ to 3×10⁵, preferably 2×10⁰ to 2×10⁵, more preferably 3×10⁰ to 1.5×10⁵ and in particular 5×10⁰ to 1.2×10⁵ Wm⁻².

The actinic radiation cure is carried out employing the conventional radiation sources and optical auxiliary measures. Examples of suitable radiation sources are flash lamps from VISIT, high-pressure or low-pressure mercury vapor lamps, with or without doping, or electron beam sources. The arrangement of these sources is known in principle and can be adapted to the circumstances of the workpiece and the process parameters. In the case of workpieces of complex shape, such as are envisaged for automobile bodies, those regions not accessible to direct radiation (shadow zones), such as cavities, folds and other structural undercuts, can be cured using pointwise, small-area or all-round emitters, in conjunction with an automatic movement means for the irradiation of cavities or edges.

The equipment and conditions for these curing methods are described for example in R. Holmes, U.V. and E.B. Curing Formulations for Printing Inks, Coatings and Paints, SITA Technology, Academic Press, London, United Kingdom, 1984, in German patent application DE 198 18 735 A1, column 10, line 31 to column 11, line 16, in R. Stephen Davidson, “Exploring the Science, Technology and Applications of U.V. and E.B. Curing”, Sita Technology Ltd., London, 1999, or in Dipl.-Ing. Peter Klamann, “eltosch System-Kompetenz, UV-Technik, Leitfaden für Anwender”, page 2, October 1998. With particular preference the actinic radiation cure is carried out under an oxygen-depleted atmosphere. “Oxygen-depleted” means that the oxygen content of the atmosphere is lower than the oxygen content of air (20.95% by volume). Preferably the maximum oxygen content of the oxygen-depleted atmosphere is 18%, more preferably 16%, very preferably 14%, with particular preference 10% and in particular 6.0% by volume.

Both the thermal cure and the actinic radiation cure can be carried out in stages. These stages may take place one after another (sequentially) or simultaneously. In accordance with the invention sequential curing is of advantage and is therefore used with preference.

The resultant thermoset materials of the invention, in particular the sheets, moldings, coatings, adhesive layers, and seals of the invention, are outstandingly suitable for the coating, adhesive bonding, sealing, wrapping, and packaging
of means of transport of all kinds, in the interior and exterior, and also parts thereof,
of buildings, in the interior and exterior, and also parts thereof, and
of doors, windows and furniture, and also,
in the context of industrial coating, in particular of hollow glassware, coils, containers, packaging, small parts, such as nuts, bolts, wheel rims or hub caps, electrical components, such as windings (coils, stators, rotors), mechanical components, optical components, and components for white goods, such as radiators, household appliances, refrigerator casings or washing-machine casings.

The substrates of the invention coated with coatings of the invention, adhesively bonded with adhesive layers of the invention, sealed with seals of the invention and/or wrapped or packaged with sheets and/or moldings of the invention have outstanding service properties in conjunction with their particularly long service life.

### INVENTIVE AND COMPARATIVE EXAMPLES

### Preparation Example 1

### The Preparation of a Methacrylate Copolymer (Binder)

A suitable reactor equipped with a stirrer, two dropping funnels for the monomer mixture and the initiator solution, a nitrogen inlet tube, thermometer, heating and a reflux condenser was charged with 650 parts by weight of an aromatic hydrocarbons fraction having a boiling range of 158 to 172° C. The solvent was heated to 140° C. Thereafter a monomer mixture of 652 parts by weight of ethylhexyl acrylate, 383 parts by weight of 2-hydroxyethyl methacrylate, 143 parts by weight of styrene, 212 parts by weight of 4-hydroxybutyl acrylate and 21 parts by weight of acrylic acid was metered into the initial charge at a uniform rate over the course of 4 hours and an initiator solution of 113 parts by weight of the aromatic solvent and 113 parts by weight of tert-butyl perethylhexanoate was metered into the initial charge at a uniform rate over the course of 4.5 hours. The addition of the monomer mixture and of the initiator solution was commenced simultaneously. After the end of the initiator feed the resulting reaction mixture was heated with stirring at 140° C. for a further 2 hours and then cooled. The resulting solution of the methacrylate copolymer was diluted with a mixture of 1-methoxyprop-2-yl acetate, butyl glycol acetate and butyl acetate.

The resulting solution had a solids content of 65%, determined in a forced-air oven (1 h/130° C.), an acid number of 15 mg KOH/g solids, an OH number of 175 mg KOH/g solids, and a glass transition temperature of −21° C.

### Preparation Example 2

### The Preparation of a Methacrylate Copolymer for Preparing an Aerosil® Paste

A laboratory reactor with a capacity of 4 l, equipped with stirrer, two dropping funnels for the monomer mixture and initiator solution respectively, nitrogen inlet tube, thermometer and reflux condenser was charged with 720 g of an aromatic hydrocarbons fraction having a boiling range of 158 to 172° C. The solvent was heated to 140° C. After 140° C. had been reached, a monomer mixture of 450 g of 2-ethylhexyl methacrylate, 180 g of n-butyl methacrylate, 210 g of styrene, 180 g of hydroxyethyl acrylate, 450 g of 4-hydroxybutyl acrylate and 30 g of acrylic acid was metered into the reactor at a uniform rate over the course of 4 hours and an initiator solution of 150 g of tert-butyl perethylhexanoate in 90 g of the aromatic solvent described was metered into the reactor at a uniform rate over the course of 4.5 hours. The addition of the monomer mixture and of the initiator dilution was commenced simultaneously. After the end of the initiator feed the reaction mixture was held at 140° C. for two further hours and then cooled. The resulting polymer solution had a solids content of 65%, determined in a forced-air oven (1 h/130° C.), an acid number of 15 mg KOH/g and a viscosity of 3 dPas (measured on a 60% dilution of the polymer solution in the aromatic solvent described, using an ICI cone and plate viscometer at 23° C.).

### Preparation Example 3

### The Preparation of an Aerosil® Paste

A laboratory agitator mill from Vollrath was charged with 800 g of millbase, consisting of 323.2 g of the methacrylate copolymer of preparation example 2, 187.2 g of butanol, 200.8 g of xylene and 88.8 g of Aerosil® 812 (Degussa AG, Hanau (DE)), together with 1100 g of quartz sand (particle size 0.7-1 mm), and this millbase was dispersed with water cooling for 30 minutes.

### Examples 1 (Inventive) and C1 (Comparative)

### The Preparation of the Clearcoat Material 1 of Example 1 and of the Clearcoat Material C1 of Comparative Example C1

The clearcoat materials 1 and C1 were prepared by mixing the constituents indicated in table 1, in the order indicated, and homogenizing the resulting mixtures.

TABLE 1
The physical composition (parts by weight) of the clearcoat
material 1 of example 1 (Ex. 1) and of the clearcoat
material C1 of comparative example C1 (Ex. C1)

| Constituent | Ex. 1 | Ex. C1 |
|---|---|---|
| Component (A): | | |
| Binder of preparation example 1 | 33.6 | 33.6 |
| Setalux ® C91756 | 14.4 | 14.4 |
| (Akzo Nobel Resins, Bergen op Zoom | | |
| (NL); rheology control additive) | | |
| Aerosil ® paste of preparation example 3 | 2.9 | 2.9 |
| Sartomer ® 444D (pentaerythrityl | 19.2 | 19.2 |
| triacrylate) | | |
| Butyl acetate 98/100 | 25.9 | 25.9 |
| Mixture (L) of 2-(4-((2-hydroxy-3- | 1.0 | — |
| undecyloxypropyl)oxyl)-2-hydroxy- | | |
| phenyl)-4,6-bis(2,4-dimethylphenyl)- | | |
| 1,3,5-triazine and 2-(4-((2-hydroxy- | | |
| 3-tridecyloxypropyl)oxyl)-2-hydroxy- | | |
| phenyl)-4,6-bis(2,4-dimethylphenyl)- | | |
| 1,3,5-triazine (Tinuvin ® 400 from | | |
| Ciba Spezialitätenchemie) | | |
| Trial product (L) from Ciba | 1.0 | — |
| Spezialitätenchemie Tinuvin ® CGL 052, | | |
| comprising one triazine group and two | | |
| cyclic, sterically hindered amino | | |
| ether groups | | |
| 2-(2-hydroxy-3,5-di-tert-amylphenyl)- | — | 1.0 |
| 2H-benzotriazole (Tinuvin ® 328 from | | |
| Ciba Spezialitätenchemie) | | |
| Bis(1,2,2,6,6-pentamethyl-4- | — | 1.0 |
| piperidyl) sebacate (Tinuvin ® 292 | | |
| from Ciba Spezialitätenchemie) | | |
| 1-[4-(2-hydroxyethoxy)phenyl]-2- | 1.0 | — |
| hydroxy-2-methyl-1-propan-1-one (P) | | |
| (Irgacure ® 2959 from Ciba | | |
| Spezialitätenchemie) | | |
| Diphenyl(2,4,6-trimethyl- | 0.5 | 0.5 |
| benzoyl)phosphine oxide (Lucirin ® TPO | | |
| from BASF Aktiengesellschaft) | | |
| 1-hydroxycyclohexyl phenyl ketone | — | 1.0 |
| (Irgacure ® 184 from Ciba | | |
| Spezialitätenchemie) | | |
| Additive (Byk ® 375 from Byk Chemie) | 0.5 | 0.5 |
| Total: | 100 | 100 |
| Component (B): | | |
| Isocyanato acrylate Roskydal ® UA VPLS | 37.34 | 37.34 |
| 2337 from Bayer AG (basis: trimeric | | |
| hexamethylene diisocyanate; | | |
| isocyanate group content: 12% by | | |
| weight) | | |
| Isocyanato acrylate Roskydal ® UA VP | 9.34 | 9.34 |
| FWO 3003-77 from Bayer AG, based on | | |
| the trimer of isophorone diisocyanate | | |
| (70.5% in butyl acetate; viscosity: | | |
| 1500 mPas; isocyanate group content: | | |
| 6.7% by weight) | | |
| Desmodur ® N 3300 from Bayer AG | 6.65 | 6.65 |
| (trimeric hexamethylene diisocyanate) | | |
| Butyl acetate 98/100 | 4.67 | 4.67 |
| Total: | 58 | 58 |

The clearcoat materials 1 and C1 had a very good pot life and very good application characteristics. In particular they exhibited outstanding flow and an especially low tendency to form runs, and so could be applied without problems even at high film thicknesses.

### Examples 2 and C2

### The Production of the Multicoat Paint System 1 of Example 2 and of the Multicoat Paint System C1 of Comparative Example C2

The multicoat paint system 1 of example 2 was produced using the clearcoat material 1 of example 1.

Multicoat paint system C1 of comparative example C2 was produced using the clearcoat material C1 of comparative example C1.

The multicoat paint systems 1 and C1 were produced by coating steel panels with electrocoats that were deposited cathodically and baked at 170° C. for 20 minutes, in a dry film thickness of 18 to 22 μm. Subsequently the steel panels were coated with a commercially customary two-component water-based surfacer from BASF Coatings AG, such as is commonly used for polymeric substrates. The resultant surfacer films were baked at 90° C. for 30 minutes, to give a dry film thickness of 35 to 40 μm. Thereafter a commercially customary metallic aqueous basecoat material from BASF Coatings AG was applied with a film thickness of 12 to 15 μm in each case, after which the resulting aqueous basecoat films were flashed off at 80° C. for ten minutes. Subsequently the clearcoat materials 1 and 2 were applied pneumatically in one cross-pass, using a gravity-feed cup-type gun, in film thicknesses of 40 to 45 μm in each case.

The aqueous basecoat films and the clearcoat films 1 and C1 were cured at room temperature for 5 minutes and at 80° C. for 10 minutes, followed by irradiation with UV light in a dose of 104 J m⁻² (1000 mJ cm⁻²) and a radiation intensity of 83 W m⁻², using an iron-doped mercury vapor lamp from IST, and finally at 140° C. for 20 minutes. This gave the multicoat paint systems 1 and C1.

The multicoat paint systems 1 and C1 were equivalent and had an outstanding profile of properties in terms of gloss, transparency and clarity, weathering stability and yellowing stability, etch resistance, scratch resistance and acid resistance. Surprisingly they also had a high condensation resistance, as determined by means of the conventional constant condensation conditions (CCC) test.

### Examples 3 and C3

### The Emissions Behavior of the Clearcoats Produced From the Clearcoat Materials

For example 3 the clearcoat material 1 of example 1 was used. It was applied to an aluminum sheet in a wet film thickness such that, after thermal curing at room temperature for 5 minutes and at 80° C. for 10 minutes, and after radiation curing with an iron-doped mercury vapor lamp from IST, with UV light in a dose of 10⁴ Jm⁻² (1000 mJ cm⁻²) and a radiation intensity of 83 W m⁻², the resulting clearcoat 1 had a dry film thickness of 40 μm.

For comparative example C3 the clearcoat material C1 of comparative example C1 was used. The clearcoat C1 was produced as indicated in example 3, but using the clearcoat material C1 instead of the clearcoat material 1. This gave the clearcoat C1.

The emissions behavior of the clearcoats 1 and C1 was determined in accordance with the recommended method published by the Verband der Automobilindustrie [VDA; Automobile Industry Association], VDA 278 (09/2002 edition), “Thermodesorptionsanalyse organischer Emissionen zur Charakterisierung von nichtmetallischen KFZ-Werkstoffen” [Thermal desorption analysis of organic emissions for characterizing nonmetallic automotive materials]. Accordingly a determination was made of the substances released at 90° C. (VOC) and those released at 120° C. (FOG) . In the present case portions of the clearcoats 1 and C1 were heated in a stream of inert gas and the substances released in the course of such heating were frozen out in the deep-cooled injector of a gas chromatograph at −150° C. After the respective mixtures of substances had been separated the individual substances were identified as far as possible using a mass-selective detector. The VOC and FOG measurements were carried out with the same partial samples. The gaseous emissions (VOC) were quantified against an external toluene standard, while the condensable emissions (FOG) were quantified against hexadecane.

For the clearcoat 1 the result was a total emission VOC of 3 ppm (limit: 100 ppm) and a total emission FOG of 118 ppm (limit: 250 ppm).

Conversely, for the clearcoat C1 the result was a total emission VOC of 158 ppm (limit: 100 ppm) and a total emission FOG of 1302 ppm (limit: 250 ppm).

Consequently the two clearcoats differed from one another significantly in terms of their emissions behavior. Whereas in the case of clearcoat 1 the total emissions were well below the limits, those limits were greatly exceeded in the case of the clearcoat C1.

1. A multicomponent systems, comprising:
(A) at least one component (A) comprising
contains isocyanate-reactive functional groups,
is free from isocyanate groups, and
(B) at least one component (B) comprising
contains isocyanate groups,
is free from isocyanate-reactive functional groups, and
wherein at least one of the two components, (A) or (B), further comprises functional groups having bonds which can be activated with actinic radiation, and at least one components (A) comprises
(L) at least one light stabilizer, selected from the group consisting of low molecular mass, oligomeric and polymeric light stabilizers which contain at least one isocyanate-reactive functional group, and
(P) at least one photoinitiator which contains at least one isocyanate-reactive functional group.

2. The multicomponent system of claim 1, wherein the isocyanate-reactive functional groups are selected from the group consisting of hydroxyl groups, thiol groups and primary and secondary amino groups.

3. The multicomponent system of claim 2, wherein the isocyanate-reactive functional groups are hydroxyl groups.

4. The multicomponent system claim 1, wherein the light stabilizers (L) are selected from the group consisting of UV absorbers and reversible free-radical scavengers.

5. The multicomponent system of claim 4, wherein the UV absorbers (L) are selected from the group consisting of benzotriazoles and triazines, and the reversible free-radical scavengers (L) from the group consisting of sterically hindered cyclic amines.

6. The multicomponent system of claim 1, wherein the photoinitiators (P) are selected from the group consisting of benzil monoketals, acetophenone derivatives, benzyl formates, monoacylphosphine oxides and diacylphosphine oxides.

7. The multicomponent system of claim 6, wherein the photoinitiators (P) are acetophenone derivatives.

8. The multicomponent system of claims 1, wherein components (A), (B), or a combination thereof, comprise at least one light stabilizer which is free from isocyanate-reactive functional groups.

9. The multicomponent system of claim 1, wherein components (A), (B), or a combination thereof, comprise at least one photoinitiator which is free from isocyanate-reactive functional

10. The multicomponent system of claim 9, wherein the photoinitiator, which is free from isocyanate-reactive functional groups, is of low or zero volatility.

11. The multicomponent system of claim 1, wherein the actinic radiation is UV radiation.

12. The multicomponent system of claim 1, wherein the bonds, which can be activated with actinic radiation, are olefinic double bonds.

13. The multicomponent system of claim 12, wherein the reactive functional groups which contain olefinic double bonds, which can be activated with actinic radiation, are acrylate groups, methacrylate groups or a combination thereof.

14. A process for preparing a multicomponent system, comprising:
(A) at least one component (A) comprising
isocyanate-reactive functional groups,
is free from isocyanate groups, and
(B) at least one component (B) comprising
isocyanate groups,
is free from isocyanate-reactive functional groups, and
wherein at least one of the two components, (A) or (B), further comprises functional groups having bonds which can be activated with actinic radiation, by the separate preparation of components (A) and (B), wherein at least one components (A) comprises
(1) at least one light stabilizer (L), selected from the group consisting of low molecular mass, oligomeric and polymeric light stabilizers which contain at least one isocyanate-reactive functional group, and
(2) at least one photoinitiator (P) which contains at least one isocyanate-reactive functional group.

15. The process of claim 14, which is carried out in the absence of actinic radiation.

16. The process of claim 14, wherein the process for preparing a multicomponent system comprises preparing mixtures curable thermally and with actinic radiation (dual-cure mixtures).

17. The process of claim 16, wherein the dual-cure mixtures serve for producing dual-cured thermoset materials, sheets, moldings, coatings, adhesive layers, and seals.

18. The process of claim 17, wherein the coating materials serve for producing single-coat systems, multicoat systems, and a combination thereof.

19. The process of claim 17, wherein the coating materials are electrocoat, primer, clearcoat, solid-color topcoat and basecoat materials, surfacers and antistonechip primers for producing electrocoats, primer coats, surfacer coats and antistonechip primer coats, basecoats, solid-color topcoats, and clearcoats.

20. The process of claim 17, wherein the moldings, sheets coating materials, adhesives, or sealants are used for wrapping, packaging, surface-coating, or adhesively bonding and sealing
means of transport, in the interior and exterior, and also parts thereof,
buildings, in the interior and exterior, and also parts thereof,
doors, windows and furniture, and
in the context of industrial coating, hollow glassware, coils, containers, packaging, small parts, electrical, mechanical and optical components, and components for white goods.

21. The multicomponent system of claim 1, wherein the multicomponent system comprises preparing mixtures curable thermally and with actinic radiation (dual-cure mixtures).

22. The multicomponent system of claim 1, wherein component (A) or component (B) further comprises functional groups having bonds which can be activated with actinic radiation.

23. The multicomponent system of claim 1, wherein component (A) or component (B) is free of functional groups having bonds which can be activated with actinic radiation.
